(19) United States
(12) Patent Application Publication
(10) Pub. No.: US 2023/0375990 A1
(43) Pub. Date: Nov. 23, 2023

(54) SYSTEMS AND METHODS FOR MULTI-PERIOD OPTIMIZATION FORECASTING WITH PARALLEL EQUATION-ORIENTED MODELS

(71) Applicant: ConocoPhillips Company, Houston, TX (US)

(72) Inventors: Bradley G. Babcock, Houston, TX (US); Emma Risinger, Houston, TX (US); Michael T. Maher, Houston, TX (US); Christopher Widner, Houston, TX (US)

(21) Appl. No.: 18/200,020

(22) Filed: May 22, 2023

Related U.S. Application Data
(60) Provisional application No. 63/344,160, filed on May 20, 2022.

(51) Int. Cl. G05B 13/04

(52) U.S. Cl. CPC G05B 13/048

(57) ABSTRACT

Implementations described and claimed herein provide systems and methods for a scripting technique to clone equation-oriented models of a modeled system for parallel simulation of the modeled system. The multiple equation-oriented models may be solved in parallel to quickly create an optimized solution for different operating conditions by providing different input variable sets to the cloned equation-oriented models. The multiple equation-oriented models may provide real-time optimization of the modeled system to provide continuous optimization of all controls or handles of the system to help achieve a target performance of the system. The equation-oriented models may also provide a nomination tool to predict the output of the system over a nomination period with different input variables and performance monitoring capabilities of the system. Offline “what-if” simulations may also be executed on the equation-oriented modeling system to aid operators in predicting performance of the modeled system and troubleshoot potential problems.

### CROSS-REFERENCE TO RELATED APPLICATIONS

The present application claims priority to U.S. Provisional Patent Application No. 63/344,160, filed May 20, 2022 and titled “SYSTEMS AND METHODS FOR MULTI-PERIOD OPTIMIZATION FORECASTING WITH PARALLEL EQUATION-ORIENTED MODELS,” which is incorporated by reference in its entirety herein.

### FIELD

Aspects of the present disclosure relate generally to systems and methods for developing forecasts and models of liquified natural gas (LNG) processing and, more particularly, to predictive modeling to forecast LNG production in a facility utilizing multiple cloned equation-oriented models with varying inputs for paralleled multi-period forecasts.

### BACKGROUND

Natural gas generally refers to rarefied or gaseous hydrocarbons (which may be comprised of methane and light hydrocarbons such as ethane, propane, butane, and the like) which are found in the earth. It is common practice to cryogenically liquefy natural gas so as to produce a liquefied natural gas product (“LNG”) for more convenient storage and/or transport to one or more markets. Liquefaction of natural gas is typically conducted at an LNG liquification or processing plant. Many LNG liquefaction plants utilize several components to prepare the natural gas for storage and/or transport, include mechanical refrigeration units for the cooling of the inlet gas stream, heat exchanges with one or more refrigerants such as propane, propylene, ethane, ethylene, nitrogen and methane, or mixtures thereof, in a dosed loop or open loop configuration, storage tanks, feed controllers, and the like. Proper and efficient operation of the components of the LNG facility may affect the productivity of the LNG plant. For example, ambient temperature of the plant, feed gas flow, and other variables may determine the efficiency (perhaps measured in plant production in relation to energy expended) of the plant and proper control of the plant components may increase the efficiency of the plant. However, large facilities may include hundreds of components, one or more of which may be controllable, and all which may affect the efficiency of the plant output and make the LNG plant more or less profitable.

It is with these observations in mind, among others, that various aspects of the present disclosure were conceived and developed.

### SUMMARY

Implementations described and claimed herein address the foregoing problems by providing systems and methods for generating a performance prediction of a processing plant. The systems and methods may generate, using a processing device, an equation-oriented model of a natural gas facility (e.g., a Liquid Natural Gas (LNG) facility), the equation-oriented model comprising a plurality of equations corresponding to processing components of the natural gas facility (e.g., the LNG facility) and execute a script to automatically generate a plurality of cloned equation-oriented models of the natural gas facility. The systems and methods may also generate a plurality of input value sets each representing a different operating condition of the natural gas facility and apply, in parallel, each of the plurality of input value sets to at least one of the plurality of cloned equation-oriented models to generate a plurality of natural gas facility performance predictions.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting. As used herein, a continuous or semi-continuous process can be used in any hydrocarbon processing facility, examples include hydrocarbon processing, unconventional resource processing, steam-assisted gravity drainage process, tight-gas liquids processing, natural gas processing water treatment processing, coal-bed methane processing, methane processing, gas production processing, liquified natural gas processing, ethylene processing, nitrogen and carbon dioxide processing.

### BRIEF DESCRIPTION OF THE DRAWINGS

FIG. 1 shows an example network environment that may implement various systems and methods discussed herein.

FIG. 2 is a block diagram illustrating an example sequential modeling technique and an equation-oriented modeling technique.

FIG. 3 illustrates example operations for utilizing equation-oriented models to make performance predictions of a system.

FIG. 4 is a block diagram illustrating example data flow for utilizing multiple cloned equation-oriented models for modeling a system.

FIG. 5 is a block diagram illustrating functionality for modeling a system that includes a multiple cloned equation-oriented models.

FIG. 6 shows an example block diagram of an equation-oriented model cloning system for generating forecast model of a system.

FIG. 7 shows an example computing system that may implement various systems and methods discussed herein.

### DETAILED DESCRIPTION

Aspects of the present disclosure involve systems and methods for using a script or scripts to clone reduced order equation-oriented models generated based off of a rigorously modeled system. In general, equation-oriented steady state models solve all unit operations within the flowsheet simultaneously, much faster than a sequential steady state model. Cloning a rigorous equation oriented model sometimes results in prohibitive solve times. The scripting techniques disclosed herein extract relationships (gains) between independent variables and key constrained dependent variables. These relationships are used to generate the cloned equation oriented model. Disturbance variables that impact the system can be incorporated into a forecasted profile, and the cloned equation oriented model can determine what is the most profitable way to run the asset over the period of time considering how those disturbances affect the process. For example, the cloned equation-oriented models may be used to create a multi-period forecast to maximize profit (and/or production and/or efficiency) of a liquified natural gas (LNG) facility or plant. Optimized solutions over the course of a 24-hour nomination period for the modeled system may be visualized while taking into account forecasted ambient temperature changes, forecasted feed stock changes, forecasted ship loading schedules, forecasted reduced feed for planned or unplanned maintenance, etc. Further, the cloned equation-oriented models may be solved in parallel to quickly produce multi-period optimized solutions. For example, 24 cloned models can be created and solved simultaneously taking into account the forecasted disturbance profiles. Every time the cloned multi-period optimization problem solves, it can run with the latest forecasted disturbance profiles. Through the scripting technique to clone the equation-oriented models, a rigorous, first principles optimization model may be generated that provides operating setpoint recommendations to maximize system output, setpoint recommendations may be calculated in real-time to optimize system output, and/or recommendations for optimizing the modelled system may be provided at recurring intervals during operation of the modelled system. The scripting technique may also adjust by updating the forecast in real-time as actual operating conditions vary throughout the nomination period. These and other advantages may become apparent from the discussion included herein.

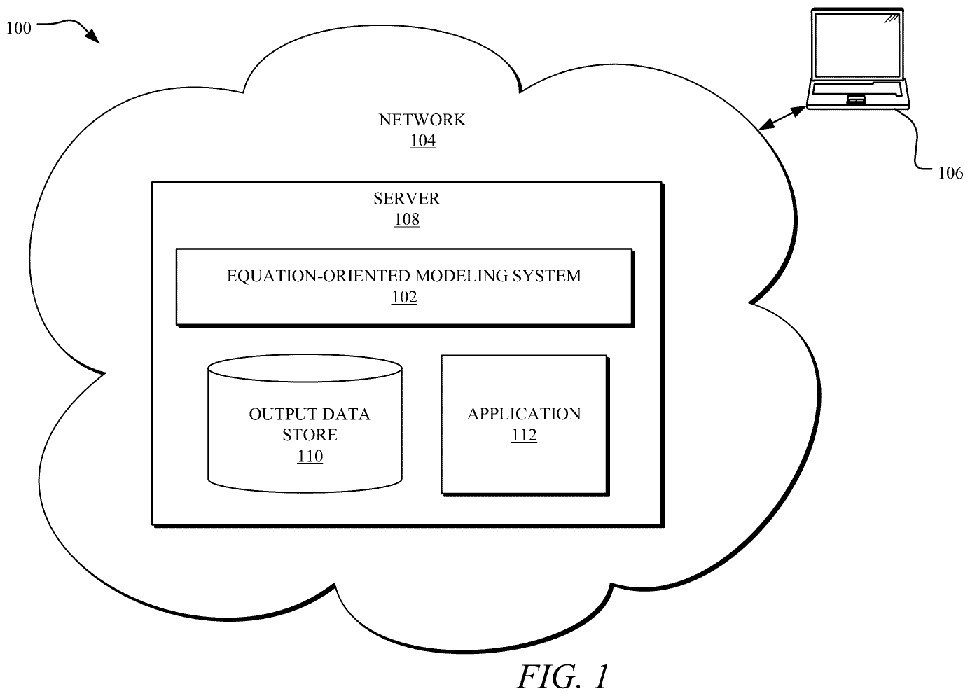

To begin a detailed discussion of an example asset development system 100, reference is made to FIG. 1. FIG. 1 illustrates an example network environment 100 for implementing the various systems and methods, as described herein. As depicted in FIG. 1, a network 104 is used to host one or more computing or data storage devices for implementing the systems and methods for generating one or more equation-oriented models using the equation-oriented modeling system 102. A server 108 can be the host for the equation-oriented modeling system 102 and a database 110. Users can access historized outputs from the equation-oriented models 102 on one or more user devices 106. Examples of the user devices 106 include a terminal, personal computer, a smart-phone, a tablet, a mobile computer, a workstation, and/or the like.

A server 108 may, in some instances, host the system. In one implementation, the server 108 also hosts a website or an application 112 that users may visit to access output data stored 110 from the equation-oriented modeling system 102. The server 108 may be one single server, a plurality of servers with each such server being a physical server or a virtual machine, or a collection of both physical servers and virtual machines. In another implementation, a cloud hosts one or more components of the system. The equation-oriented modeling system 102, the user devices 106, the server 108, and other resources connected to the network 104 may access one or more additional servers for access to one or more websites, applications, web services interfaces, etc. that are used to model a process using an equation-oriented model (e.g., reservoir modeling).

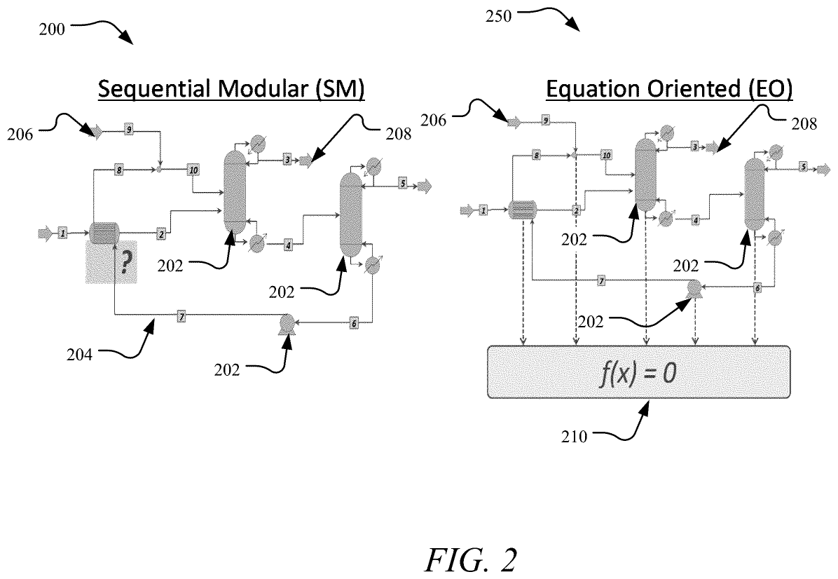

FIG. 2 is a block diagram illustrating solving the same physical flowsheet in two approaches: using a sequential modular approach 200 (or modeler) or using an equation oriented approach 250 (or modeler). The flowsheet attempts to model a generic process which may include several unit operations/equipment 202 (such as condensers, refrigerators, storage tanks, valves, etc.) interconnected through one or more pipes 204. The sequential modular approach 200 and/or the equation oriented approach 250 may also include one or more inputs 206 (such as natural gas/feed stream) and one or more outputs 208 (such as LNG production/product). In the sequential modular approach 200, the input from 206 is solved sequential based on the flow of information. The input 206 (e.g., depicted as stream 9) is combined with an unknown information from stream 8, which is a feed into the first unit operation/equipment 202. To solve this problem, one would have to keep sequentially stepping through each unit operation 202 until there is a known quantity for stream 8 and the problem solves to a given tolerance. The speed of this approach is a function of how many recycle streams and integrations are involved, and can require many iterations of solving the whole process.

In the equation-oriented approach 250, all equations that describe the entire system can be solve simultaneously. For example, the equation-oriented approach 250 of FIG. 2 still includes all of the equations that describe the same unit operations/equipment 202, inputs 206, and outputs 208, however, the solving method is different than the sequential modular approach. The equation-oriented approach 250 can improve on the sequential modular approach 200 by offering no inherent directionality of computation, can solve calibration and optimization problems using a single process model, and a repeatable; faster solution; making it possible to deploy large, complex models in demanding situations such as online real-time optimization.

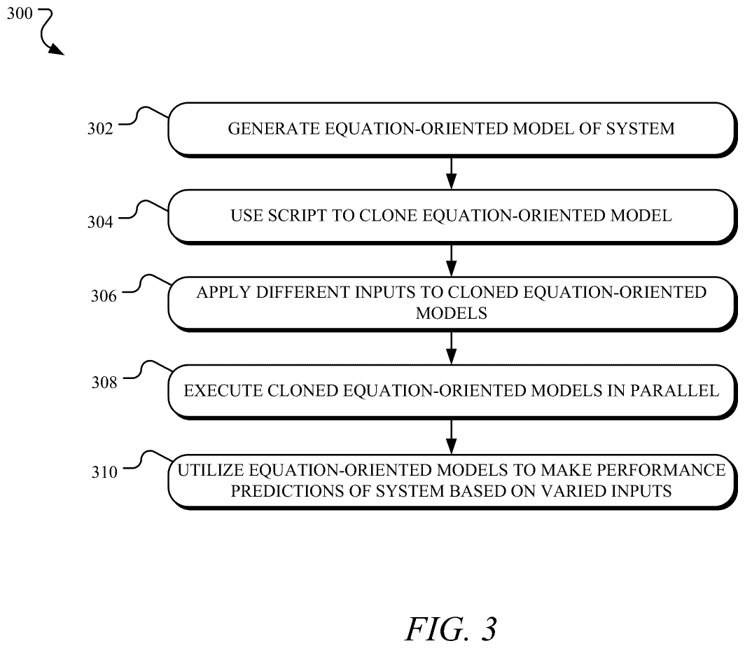

While the equation-oriented approach 250 may be used to model and/or solve a system (such as an LNG processing system or plant) faster than the sequential modular approach 200, the model is limited to a particular set of inputs or operating conditions for modeling at a time. Thus, the equation-oriented approach is able to answer the question of how best to operate a facility at this point in time. FIG. 3 illustrates example operations for utilizing equation-oriented models to make forecasted predictions of a system and answer the question of how best to operate a facility over a period of time. The operations may be performed by a computing device configured to execute any algorithm, including equation-oriented modeling techniques. Such operations may be executed through control of one or more hardware components, one or more software programs, or a combination of both hardware and software components of the computing device.

Beginning at operation 302, the computing device may generate an equation-oriented model 250 of a system to answer the question of how the facility should operate at a particular point in time. This model and solution can be used as the basis for a reduced order cloned equation oriented model. The relationships between independent variables and constrained dependent variables can be extracted during the next step 304. Those extracted relationships only are cloned multiple times to create a multi-period problem. Prior to solving the cloned equation oriented problem, all desired forecasted profiles are applied to the problem at step 306. The cloned equation oriented model solves simultaneously using the equation oriented approach 308. Outputs from the cloned equation oriented model are used to provide forecasted guidance on how to best operate the facility over a period of time 310. In one particular example, the computing device may generate an equation-oriented model of an LNG processing plant or a portion of the processing plant. The equation-oriented model 250 may reduce the components of the system to a set of equations for processing of inputs to the model that may be solved simultaneously. Through the use of the equation-oriented model 250, a performance or output of the system may be obtained quickly based on a set of inputs 206 provided to the model

At operation 304, a script may be executed that clones the equation-oriented model 250 any number of times. The cloning script may generate multiple instances of the equation-oriented model 250 for the system, including the set of equations that may be executed to model the system. The cloning script may be configured or controlled to generate a particular number of cloned equation-oriented models 250 to correspond to a number of varying operating or nomination conditions over a time period. For example, the cloning script may generate 24 equation-oriented models for a nomination period of 24 hours. More or fewer cloned equation-oriented models may be generated by the cloning script, as determined by the computing device.

Varied inputs may be provided to the cloned equation-oriented models at operation 306. For example, a first equation-oriented model may be given a first set of inputs to the model to represent a particular operating condition of the system. Simultaneously, a second equation-oriented model may be given a second set of input to represent a second particular operating condition of the system. Such inputs may include any variable to the modeled system, such as ambient temperature, feed stock changes, ship loading schedules, reduced feed for planned or unplanned maintenance, and the like. In general, any operating condition of the system may be provided as an input to the cloned equation-oriented models. Such operating conditions may be selected based on a projected outcome of the equation-oriented models, such as a production estimate or efficiency estimate of the system. Through the multiple cloned equation-oriented models, an optimized solution for different operating conditions may be modeled.

At operation 308, each of the cloned equation-oriented models may be executed in parallel to obtain the optimized solution for the different operating conditions. In particular, although the cloned equation-oriented models may include the same equations to model the system, the different input sets provided to each of the equation-oriented models may result in a different output from the models. Further, each of the cloned equation-oriented models may be executed in parallel by one or more computing devices. For example, separate virtual machines or cloud devices may be provided with one or more of the cloned equation-oriented models for execution such that each model may be executed simultaneously or otherwise in parallel. In another example, a local computing device may be configured to execute each of the cloned equation-oriented models in parallel. Regardless of the infrastructure upon which the cloned equation-oriented models are executed, the results of several simulations may be obtained at once. In particular, at operation 310, the cloned equation-oriented models may be utilized to make performance predictions of the modeled system based on the varied inputs. For example, a first set of input variables may be provided to a first cloned equation-oriented model to obtain a first system output based on a scenario represented by the first set of input variables. A second set of input variables may be provided to a second cloned equation-oriented model to obtain a second system output, with the second set of input variables representing a second system condition or scenario. By modeling the system performance multiple times with varying input values, different operating conditions of the system may be modeled to obtain a performance prediction of the system. In the example of an LNG processing plant model, the input variables may include ambient temperature and/or feed gas flow (among other input variables) and the performance predictions may include facility profit in terms of gas output and profitability of the system. In general, however, any number of input variables may be provided to the cloned equation-oriented models to obtain any number of system performance predictions. Through the use of the cloned equation-oriented models, such performance predictions may be obtained faster and more efficiently than systems which model the different system scenarios in a linear manner.

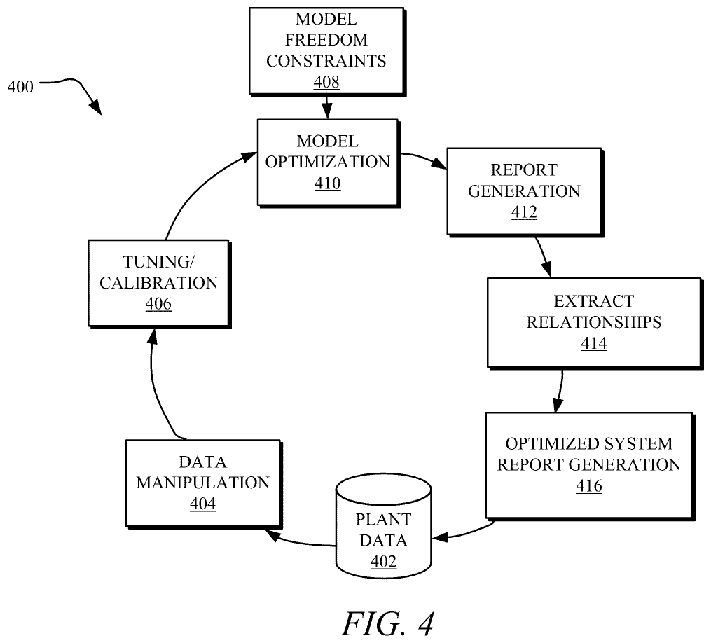

FIG. 4 is a block diagram illustrating example data flow 400 (e.g., method) for utilizing the multiple cloned equation-oriented models for modeling a system. The data flow 400 illustrates a cycle through which a simulator or modeler may follow to generate the forecasted predictions of the modeled system utilizing the cloned equation-oriented models of the system. For example, plant data 402 (e.g., or other data) from a system (such as an LNG processing plant) may be collected through various sensors incorporated into the system. Such data may comprise several thousand variables that may be used as input to a model or models and may be collected at various intervals, such as every second. The plant data 402 may be cleaned, validated, or otherwise manipulated 404 to identify and/or remove erroneous sensor outputs or incongruous sensor readings to ensure that the model uses accurate readings from the system or plant. In one example, a 20-minute rolling average of variable data may be checked for gross errors/dropouts. Such a validation may include comparing the received data to one or more threshold values to determine an accuracy of the received readings from the system sensors.

Following the data manipulation 404, one or more of the cloned equation-oriented model, which is a rigorous process model that answers the question of how best to operate this facility at the particular point in time, can be tuned and/or calibrated 406. The tuning/calibration 406 may include calibrating the cloned equation-oriented models against a new dataset of input values, such as the validated data set after data manipulation 404. The equation-oriented models may then be optimized 410, perhaps based on one or more model freedom constraints 408. For example, model freedom constraints 408 may include input process constraints to ensure suggested setpoint recommendations for components of the system received from the models are feasible. In another example, input variables independent of the system, such as input feed gas and/or pricing information, may also be provided as model freedom constraints 408. The model freedom constraints 408 may also include indications of particular control variables for the system. For example, some modeled systems may include devices or other components that are controllable based on the various sensor readings to generate a particular output value for the system. The model freedom constraints 408 may therefore indicate which components are controllable in the modeled system for adjustments to the system or plant performance. As discussed below, the output of the equation-oriented model may include adjustment or setting recommendations for such controllable components to obtain a particular performance prediction for the system or plant.

The model freedom constraints 408 may be provided to the model optimizer 410 to alter the model based on the model freedom constraints 408. In one instance, the model may be altered to include new recommended setpoints for the controllable aspects or components of the equation-oriented model. Such an optimization may be determined to maximize a system output, such as a facility profitability subject to process and/or nomination constraints. In other instances, the optimization may include altering or adjusting some aspect of the equations of the model of the system. In general, the model optimization 410 provides an output of one or more simulations of the equation-oriented model to generate a control recommendation based on a target system performance prediction.

A report including the model optimization 410 output may be generated as an optimization report 412. In one particular instance, a report may be generated at a particular interval for system optimization and/or monitoring, such as every 15 minutes, although a report may be generated for any length of interval. The optimization report can represent an optimized operation parameter for a particular asset of the plant for the particular point in time. The report may also include an indicator of the types and/or identifiers of system controls which are most often adjusted through the optimization process. The identified controls may be potentially holding back processing of an input variable such that identification of such controls may provide an indication of areas for increased efficiency in the operation of the system. Following the generation of the optimization report at step 412, the data flow 400 can extract relationships 414 between independent variables and constrained dependent variables of the optimized model generated from step 412. The extracted relationships can be cloned to form a cloned model represent additional points in time or time periods to evaluate an optimized operation over a longer and/or future period of time. Disturbance profiles of interest can be overlayed over the extracted relationships. Moreover, the cloned model can be tuned/calibrated followed by additional optimization. Then the optimized system settings may be applied to the equation-oriented model by generating a multi-period cloned optimized system report 415 such that a new simulation may be executed with the optimized settings and compared to the plant data 402 obtained from the system sensors. This cycle can be repeated via an iteration process. Through the data flow 400 of FIG. 4, optimized operations of the system may be determined and reported to enhance the performance output of the system based on one or more performance predictions of the system.

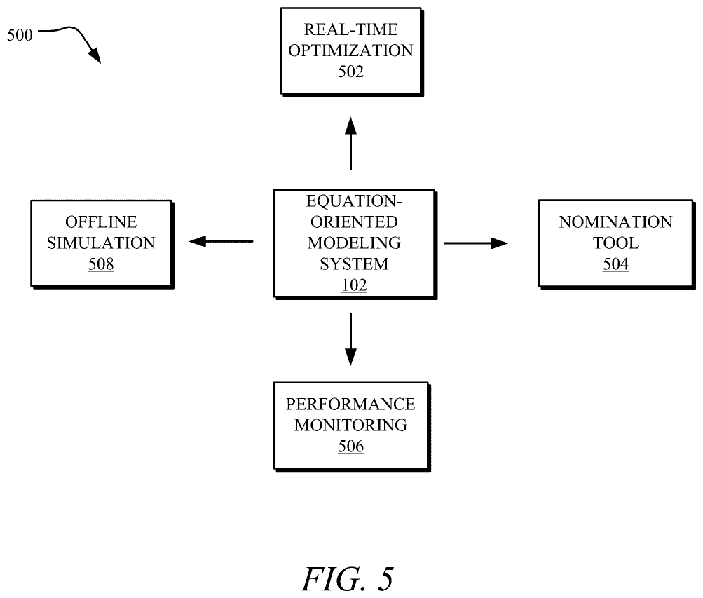

FIG. 5 is a block diagram 500 illustrating functionality of a multiple cloned equation-oriented models for modeling a system. The multiple cloned equation-oriented models provide rigorous, first principles optimization models that support various functions utilized by engineers and operators. Operating setpoint recommendations to maximize facility profitability based on pricing of feed gas and LNG are provided and/or calculated in real-time to optimize the complete LNG facility. Such recommendations may update every 15 minutes for each train, depending on the inlet gas feed rate and efficiency of the equipment, although other intervals of updated recommendations may be provided. In one instance, the cloned equation-oriented models for modeling a system may provide for real-time optimization 502 of the modeled system to provide continuous optimization of all controls or handles of the system to help achieve a target performance of the system. The real-time optimization 502 can be the same as the model optimization 410 depicted in FIG. 4. For example, a modeled LNG facility may be optimized to maximize profits of the facility through recommended control of components of the facility. In another instance, the equation-oriented models for modeling a system 102 may provide a nomination tool 504 to predict the output of the system over a nomination period with different input variables. For example, the system may be modeled for a 24-hour forecast to maximize an output, such as a facility profit, subject to ambient temperatures and/or ship-loading profiles. Other nomination periods and input variables may be also be used by the equation-oriented modeling system 102.

The equation-oriented modeling system 102 may provide performance monitoring 506 capabilities through automatic tracking of component performance and instrument deviations by utilizing the cloned equation-oriented models. The performance monitoring 506 can be the same as the tuning/calibration 406 depicted in FIG. 4. For instance, several offline “what-if” scenarios or simulations 508 may also be performed by the equation-oriented modeling system 102. The simulations 508 can be similar to the steps 410-416 depicted in FIG. 4 and/or with some differences (e.g., the simulation cycle can be based on any dataset, such as a historical dataset and/or not necessarily in real-time) Such simulations may aid operators in predicting performance of the modeled system and troubleshoot potential problems. A variety of input values may be provided to the system for such simulations. For example, a modeled LNG facility may modeled to represent and gain understanding of feed supply limitations, feed gas composition changes, pressure variations, turbomachinery limitations, train availability, ambient temperature effects, feasibility, planned maintenance, non-linear relationships between variables, and the like. In general, any combination of input variables and control of components of the system may be utilized by the equation-oriented modeling system 102 to generate a simulation of the modeled system. Such functionality provides aid in optimizing value based on different feedstock and product pricing assumptions, among other facility performance considerations.

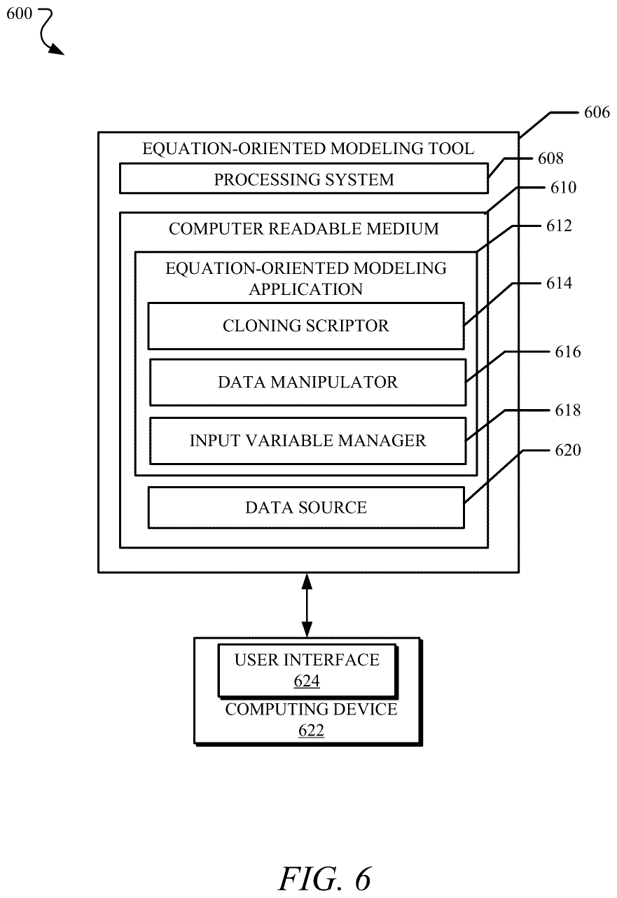

FIG. 6 shows an example block diagram of an equation-oriented modeling system 600 for generating one or more equation-oriented models of a system, such as an LNG facility. In general, the system 600 may include an equation-oriented modeling tool 606. In one implementation, the equation-oriented modeling tool 608 may be a part of the equation-oriented modeling system 102 of FIG. 1. As shown in FIG. 6, the equation-oriented modeling tool 606 may be in communication with a computing device 622 providing a user interface 624. As explained in more detail below, the equation-oriented modeling tool 606 may be accessible to various users to generate cloned equation-oriented models of a system for performance prediction and/or system monitoring. In some instances, access to the equation-oriented modeling tool 606 may occur through the user interface 624 executed on the computing device 622.

The equation-oriented modeling tool 606 may include an equation-oriented modeling application 612 executed to perform one or more of the operations described herein. The equation-oriented modeling application 612 may be stored in a computer readable media 610 (e.g., memory) and executed on a processing system 608 of the equation-oriented modeling tool 606 or other type of computing system, such as that described below. For example, the equation-oriented modeling application 612 may include instructions that may be executed in an operating system environment, such as a Microsoft Windows operating system, a Linux operating system, or a UNIX operating system environment. The computer readable medium 610 includes volatile media, nonvolatile media, removable media, non-removable media, and/or another available medium. By way of example and not limitation, non-transitory computer readable medium 610 comprises computer storage media, such as non-transient storage memory, volatile media, nonvolatile media, removable media, and/or non-removable media implemented in a method or technology for storage of information, such as computer readable instructions, data structures, program modules, or other data.

The equation-oriented modeling application 612 may also utilize a data source 620 of the computer readable media 610 for storage of data and information associated with the equation-oriented modeling tool 606. For example, the equation-oriented modeling application 612 may store information associated with the cloned equation-oriented models, input data sets, performance predictions or other outputs from the models, and the like. As described in more detail below, various generated models may be stored and used via the user interface 624 to simulate or otherwise determine system performance or conditions such that the cloned equation-oriented models may be stored in the data source 620.

The equation-oriented modeling application 612 may include several components to perform one or more of the operations described herein. For example, the equation-oriented modeling application 612 may include a cloning scriptor 614 configured to clone an equation-oriented model of the system through execution of a cloning script. The cloning scriptor 614 may be configurable to generate a set number of clones of the equation-oriented model. The set number of clones may be received, in some instances, as an input to the user interface 624 executed by the computing device 622. The cloning scriptor 614 may, upon receiving an input or indicator of the set number of clones, generate instances of the equation-oriented model. Aside from the number of generated clones, the cloning scriptor 614 may generate the cloned equation-oriented models automatically.

The equation-oriented modeling application 612 may also include a system data manipulator 616. The system data manipulator 616 may receive data from a modeled system, such as an LNG facility or plant. As described above, data from one or more sensors of the modeled system may be cleaned, validated, or otherwise manipulated to identify and remove erroneous sensor outputs or incongruous sensor readings to ensure that the equation-oriented model receives accurate inputs from the system or plant. In one example, the data manipulator 616 may check a 20-minute rolling average of variable data for gross errors/dropouts, such as through a comparison to one or more threshold values to determine an accuracy of the received readings from the system sensors. The threshold values may, in some instances, be provided to the data manipulator 616 via the user interface 624 in communication with the equation-oriented modeling tool 606. The data manipulator 616 may also remove erroneous or inaccurate data or may attempt to correct such data through one or more data correction techniques.

The equation-oriented modeling application 612 may also include an input variable manager 618 configured to manage input data sets to the cloned equation-oriented models. As described above, different input data sets may be provided to the cloned equation-oriented models to predict a system performance based on the different input sets. The input sets may therefore be utilized to determine different operating conditions for the modeled system as the model may process different input sets differently. The input variable manager 618 may store, manipulate, or otherwise control the input sets to the cloned equation-oriented models to generate the different performance predictions of the modeled system.

It should be appreciated that the components described herein are provided only as examples, and that the application 612 may have different components, additional components, or fewer components than those described herein. For example, one or more components as described in FIG. 6 may be combined into a single component. As another example, certain components described herein may be encoded on, and executed on other computing systems. Further, more or fewer of the components discussed above with relation to the equation-oriented modeling tool 606 may be included with the tool, including additional components or modules included to perform the operations of the equation-oriented modeling system 102 discussed herein.

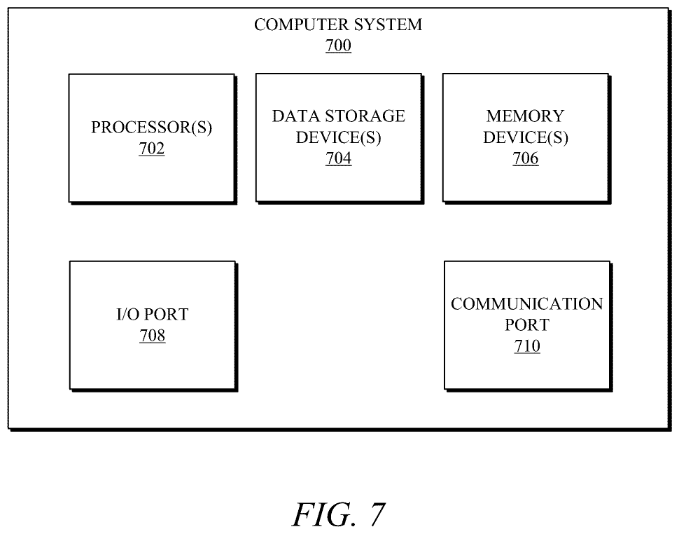

Referring to FIG. 7, a detailed description of an example computing system 700 having one or more computing units that may implement various systems and methods discussed herein is provided. The computing system 700 may be applicable to the equation-oriented modeling system 102 of FIG. 1, the system 100, and other computing or network devices. It will be appreciated that specific implementations of these devices may be of differing possible specific computing architectures not all of which are specifically discussed herein but will be understood by those of ordinary skill in the art.

The computer system 700 may be a computing system is capable of executing a computer program product to execute a computer process. Data and program files may be input to the computer system 700, which reads the files and executes the programs therein. Some of the elements of the computer system 700 are shown in FIG. 7, including one or more hardware processors 702, one or more data storage devices 704, one or more memory devices 708, and/or one or more ports 708-710. Additionally, other elements that will be recognized by those skilled in the art may be included in the computing system 700 but are not explicitly depicted in FIG. 7 or discussed further herein. Various elements of the computer system 700 may communicate with one another by way of one or more communication buses, point-to-point communication paths, or other communication means not explicitly depicted in FIG. 7.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The computer system 700 may be a conventional computer, a distributed computer, or any other type of computer, such as one or more external computers made available via a cloud computing architecture. The presently described technology is optionally implemented in software stored on the data stored device(s) 704, stored on the memory device(s) 706, and/or communicated via one or more of the ports 708-710, thereby transforming the computer system 700 in FIG. 7 to a special purpose machine for implementing the operations described herein. Examples of the computer system 700 include personal computers, terminals, workstations, mobile phones, tablets, laptops, personal computers, multimedia consoles, gaming consoles, set top boxes, and the like.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 700 includes one or more ports, such as an input/output (I/O) port 708 and a communication port 710, for communicating with other computing, network, or reservoir development devices. It will be appreciated that the ports 708-710 may be combined or separate and that more or fewer ports may be included in the computer system 700.

The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. Similarly, the output devices may convert electrical signals received from computing system 700 via the I/O port 708 into signals that may be sensed as output by a human, such as sound, light, and/or touch. The input device may be an alphanumeric input device, including alphanumeric and other keys for communicating information and/or command selections to the processor 702 via the I/O port 708. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 700 via the I/O port 708. For example, an electrical signal generated within the computing system 700 may be converted to another type of signal, and/or vice-versa. In one implementation, the environment transducer devices sense characteristics or aspects of an environment local to or remote from the computing device 700, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 700, such as, physical movement of some object (e.g., a mechanical actuator), heating or cooling of a substance, adding a chemical substance, and/or the like.

In one implementation, a communication port 710 is connected to a network by way of which the computer system 700 may receive network data useful in executing the methods and systems set out herein as well as transmitting information and network configuration changes determined thereby. Stated differently, the communication port 710 connects the computer system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 710 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 710 may communicate with an antenna or other link for electromagnetic signal transmission and/or reception.

In an example implementation, waterflood model data, and software and other modules and services may be embodied by instructions stored on the data storage devices 704 and/or the memory devices 706 and executed by the processor 702. The computer system 700 may be integrated with or otherwise form part of the dynamic waterflood modeling system 102.

The system set forth in FIG. 7 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for generating a performance prediction of a processing plant, the method comprising:
generating, using a processing device, an equation-oriented model of a natural gas facility, the equation-oriented model comprising a plurality of equations corresponding to processing components of the natural gas facility;
executing a script to automatically generate a plurality of cloned equation-oriented models of the natural gas facility;
generating a plurality of input value sets each representing a different operating condition of the natural gas facility; and
applying, in parallel, each of the plurality of input value sets to at least one of the plurality of cloned equation-oriented models to generate a plurality of natural gas facility performance predictions.

2. The method of claim 1, wherein the equation-oriented model of a natural gas facility further comprises controllable components of the natural gas facility.

3. The method of claim 2, wherein applying each of the plurality of input value sets to at least one of the plurality of cloned equation-oriented models generates one or more control recommendations for the controllable components of the natural gas facility.

4. The method of claim 1, further comprising:
receiving plant data from a sensor of the natural gas facility; and
manipulating the plant data based on one or more threshold values.

5. The method of claim 1, further comprising:
optimizing, based on a model constraint information, the equation-oriented model of the natural gas facility.

6. The method of claim 1, further comprising:
generating a report of the plurality of natural gas facility performance predictions and displaying the report on a display device of a user interface.

7. The method of claim 1, wherein applying each of the plurality of input value sets to at least one of the plurality of cloned equation-oriented models comprises simulating the plurality of cloned equation-oriented models for a determined nomination time period.

8. The method of claim 1, wherein natural gas facility is a liquified natural gas facility.

9. One or more tangible non-transitory computer-readable storage media storing instructions which, when executed by one or more processors, perform operations including:
generating an equation-oriented model of a natural gas facility, the equation-oriented model comprising a plurality of equations corresponding to processing components of the natural gas facility;
executing a script to automatically generate a plurality of cloned equation-oriented models of the natural gas facility; and
applying, in parallel, one or more input value sets to at least one of the plurality of cloned equation-oriented models to generate one or more natural gas facility performance predictions.

10. The one or more tangible non-transitory computer-readable storage media of claim 9, wherein the instructions, when executed by the one or more processors, generate a plurality of input value sets representing a plurality of different operating condition of the natural gas facility.

11. The one or more tangible non-transitory computer-readable storage media of claim 9, wherein the equation-oriented model of a natural gas facility further comprises controllable components of the natural gas facility.

12. The one or more tangible non-transitory computer-readable storage media of claim 9, wherein applying the one or more input value sets to at least one of the plurality of cloned equation-oriented models generates one or more control recommendations for controllable components of the natural gas facility.

13. The one or more tangible non-transitory computer-readable storage media of claim 9, wherein the instructions, when executed by the one or more processors, perform operations including:
receiving plant data from a sensor of the natural gas facility; and
manipulating the plant data based on one or more threshold values.

14. The one or more tangible non-transitory computer-readable storage media of claim 9, wherein applying the one or more input value sets to at least one of the plurality of cloned equation-oriented models comprises simulating the plurality of cloned equation-oriented models for a determined nomination time period.

15. A system for generating a performance prediction of a processing plant, the system comprising:
an equation-oriented model of a natural gas facility, generated using a processing device, the equation-oriented model comprising a plurality of equations corresponding to processing components of the natural gas facility;
a script to, upon execution, automatically generate a plurality of cloned equation-oriented models of the natural gas facility;
a plurality of input value sets generated to represent a plurality of different operating conditions of the natural gas facility; and
applying, in parallel, each of the plurality of input value sets to at least one of the plurality of cloned equation-oriented models to generate a plurality of natural gas facility performance predictions.

16. The system of claim 15, further comprising:
an equation-oriented modeling system including a scriptor to automatically generate the plurality of cloned equation-oriented models, the equation-oriented modeling system generating the performance prediction of a modeled processing system.

17. The system of claim 15, wherein the equation-oriented model of a natural gas facility further comprises controllable components of the natural gas facility.

18. The system of claim 15, further comprising:
model constraint information for optimizing the equation-oriented model of the natural gas facility.

19. The system of claim 15, further comprising:
a report of the plurality of natural gas facility performance predictions which is generated and displayed on a display device of a user interface.

20. The system of claim 15, wherein the natural gas facility is a liquified natural gas facility.
